(19) United States
(12) Patent Application Publication
(10) Pub. No.: US 2014/0229180 A1
(43) Pub. Date: Aug. 14, 2014

(54) METHODOLOGY OF IMPROVING THE UNDERSTANDING OF SPOKEN WORDS

(71) Applicant: Help With Listening, LaSalle (CA)

(72) Inventor: Daniel F. Watt, LaSalle (CA)

(73) Assignee: Help With Listening, LaSalle (CA)

(21) Appl. No.: 14/177,557

(22) Filed: Feb. 11, 2014

Related U.S. Application Data
(60) Provisional application No. 61/764,220, filed on Feb. 13, 2013.

(51) Int. Cl. G10L 15/18; G09B 19/04

(52) U.S. Cl. CPC G10L 15/18; G09B 19/04
USPC 704/257

(57) ABSTRACT

A methodology to improve a listeners understanding of the spoken word. The methodology comprises a large set of vocal recordings organized by categories or topics. The methodology allows the user to select a type of recording to be played and then allows the users to test the listener's ability to understand the audio recording through a user input and verification process. The methodology may also allow for the user to listen to the recording multiple times and an insert via typed words what the listeners thinks they heard. The methodology may also allow the listeners to submit the typed words and receive an evaluation as to the listener's ability to correctly hear the spoken word.

This application Claims Benefit to U.S. Provisional Patent Application Ser. No. 61/764,220—Filed Feb. 13, 2013

### BACKGROUND OF THE INVENTION

1. Field of the Invention

The present invention generally relates to a methodology for helping people understand words and more particularly, to a methodology to help people understand what they are hearing, particularly when they are learning a new language.

2. Description of Related Art

Methodologies and computer software for learning new languages have been known for many years. Many of these prior art methodologies teach new language by rote memorization of certain terms of the new language translated into the user's current language. They may also use methodologies wherein they speak completely in a new language, i.e. so called language immersion to teach a new language to a person wanting to learn such new language. However, after these programs teach the new language to a certain degree to a person they tend to fall short in helping many of these people understand what they are hearing, particularly when they are learning these new languages. The prior art language learning methodologies do not appear to aid people to better understand and comprehend what they hear in a new language but only attempt to teach them a new language.

Therefore, there is a need in the art for a methodology for use on a software, hardware web based or cloud based platform that may help and aid people in understanding what they hear in a new language, not just teaching them a new language. Furthermore, there is a need in the art for a methodology that may allow for a user of the methodology to listen to spoken sentences of their current language or a new language, thus allowing them to better comprehend what they are hearing in that language. There also is a need in the art for a methodology that uses a large set of vocal recordings stored or arranged under various categories and then use a screen of any known type that may allow interactive listening, via typing or speaking what the user of the methodology thinks they hear. There also is a need in the art for an interactive methodology that may be capable of evaluating the users input to the actual spoken word that was listened to by the user.

### SUMMARY OF THE INVENTION

One object of the present invention may be to provide a novel and unique methodology that may help users comprehend what they are hearing.

Another object of the present invention may be to provide a methodology that allows a person to better comprehend and learn a new language or their existing language.

Still another object of the present invention may be to provide a methodology that is based on a software system that uses a large set of vocal recordings arranged under various categories.

Still another object of the present invention may be to provide a methodology that interacts with a computer screen that may allow the listener to type in what they think they hear, including correct punctuation.

Still another object of the present invention may be to provide a methodology that uses a computer screen to post an evaluation of inputted data relating to what a person thinks they heard.

Yet another object of the present invention may be to provide a methodology that allows a listener to test their ability to understand an audio recording via an user input and verification process.

Still another object of the present invention may be to provide a methodology that uses a video recording of a speaker to display the speaker's image when the sound recording is played.

Still another object of the present invention may be to provide a methodology that creates a computer generated image of a talking head showing the facial responses required to make the recording by the speaker in order to display this image when the sound recording is being played.

According to the present invention, the foregoing and other objects and advantages are obtained by a novel design for a methodology to improve a listeners understanding of the spoken word. The methodology comprises a large set of vocal recordings organized by categories or topics. The methodology allows the user to select the type of recording to be played and then allows the user to test the listener's ability to understand the audio recording through a user input and verification process. The user may access various drop down menus to select the category of the recordings, the current level of the user's vocabulary, the speed at which the user wishes the recording to be spoken and which individual recording is to be used as a starting point in the present session of listening. The methodology also may allow for the user to listen to the recording multiple times and then insert via typed words what the listener thinks they heard. The methodology then allows the listener to submit the typed words and receive an evaluation as to the listener's ability to correctly hear the spoken word.

One advantage of the present invention may be that it provides a novel and unique methodology to improve a listener's understanding of the spoken word.

Another advantage of the present invention may be that it provides for a methodology that uses an interactive software to help users comprehend what they are hearing.

Still another advantage of the present invention may be that it provides a methodology wherein the persons who are learning to use a new language or wish to improve their comprehension of a newly learned language can do so via listening to the spoken word.

Yet another advantage of the present invention may be that it provides a methodology that comprises a large set of vocal recordings listed under various categories.

Still another advantage of the present invention may be that it provides a methodology for using a computer screen that allows the listener to type in what they think they hear from spoken phrases.

Still another advantage of the present invention may be that it provides a methodology that gives feedback via an evaluation of the typed words inputted by a listener.

Yet another advantage of the present invention may be that it provides a methodology that has access to a large set of vocal recordings organized by categories or topics wherein the computer screen layout allows the users to select a type of recording to be played.

Still another advantage of the present invention may be that it provides a methodology that tests the listener's ability to understand the audio recording through a user input verification process.

An additional advantage of the present invention may be that it increases the range of the user's vocabulary, and may teach proper pronunciation as the user chooses more advanced level recordings.

Yet another advantage of the present invention may be that for users whose listening comprehension is at the lower levels, the choice of readings done at slower speeds and especially with word-by-word pronunciation are important for them to gain a foothold of comprehension from which to advance in this repetitive rote based learning process.

Still another advantage of the present invention may be that it provides a methodology that uses a video recording of the speaker and then displays the speaker's image when the sound recording is played to the listener using the system.

Yet another advantage of the present invention may be that it provides a methodology that makes a computer generated image of a talking head showing the facial responses required to make the recording by the speaker, and then displaying this image when the sound recording is played to the listener.

Other objects, features and advantages of the present invention may become apparent from the subsequent description, and appended claims, taken in conjunction with the accompanying drawings.

### BRIEF DESCRIPTION OF THE DRAWINGS

FIG. 1 shows an interactive screen view before interaction by the listener.

FIG. 2 shows a screen shot after the listener makes choices.

FIG. 3 shows cards used in an alternate embodiment of the methodology to improve a listeners understanding of the spoken word.

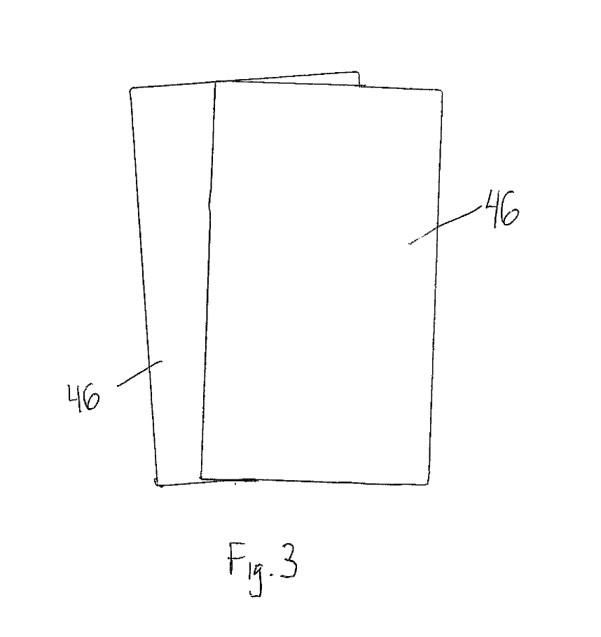

### DESCRIPTION OF THE EMBODIMENT(S)

Referring to the drawings, a methodology 10 for improving a listeners understanding of the spoken word is disclosed. Generally, the methodology 10 to improve the listeners understanding of the spoken word may be an interactive software that may help the user comprehend what they are hearing. The methodology 10 has a primary application for people who are learning to use a new language or wish to improve their comprehension of their current language or the newly learned language. The methodology 10 may be a software system that is comprised of a large set of vocal recordings listed and categorized under various categories. The methodology 10 may also use any known computer screen 12 that allows the listener to type in what they think they hear which will then be followed by an evaluation of the inputted typed words by the methodology 10. It should be noted that in one contemplated embodiment the methodology 10 is in the form of an interactive software used with any known computer, laptop, server, handheld device, including but not limited to, smart phones, calculators, tablets, writing pads, readers, or any other known electronic device capable of communicating either wirelessly or via a hard line with a remote device, a cloud based system or any other known or currently unknown computer network or electronic network capable of transferring data storing user accounts and the like. However, it should also be noted that a single device or user software may also be used for the methodology 10 to improve a listeners comprehension of the spoken word, i.e., the methodology 10 may be stored on a single computer or electronic device with no interaction with a remote system or network. It should further be noted that any type of wireless or hard wired, hard lined communication protocol may be used in conjunction with the methodologies 10 interactive software. It should further be noted that any communications during use of the methodology 10 may occur via satellite network, cable networks, or any other type of network capable of communicating with a remote station. It is also contemplated that the methodology 10 may be employed by people using and setting up seminars, classes and the like without the use of interactive software, i.e., where spoken words are relayed directly person to person for the listener using the methodology 10 and direct feedback via either the spoken word or written word is given in the same manner as that of the contemplated interactive software 10.

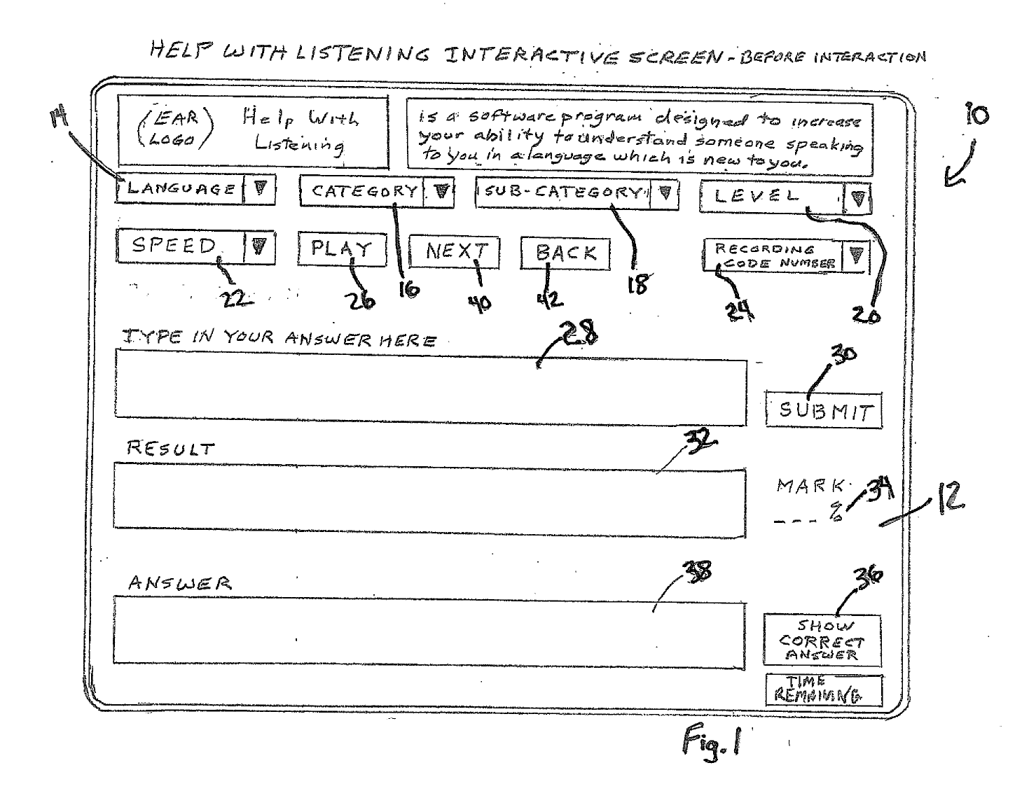

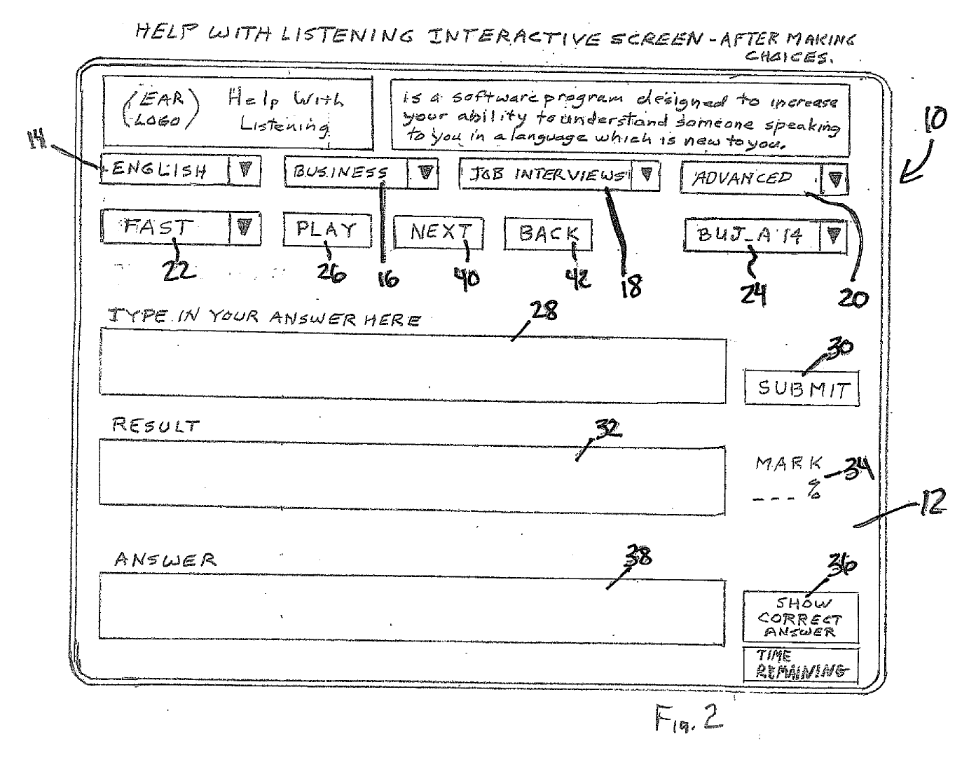

The methodology 10 as shown in FIGS. 1 and 2, may be a computer software system which has access to a large set of vocal recordings organized by categories or topics. As shown in the drawings, the computer screen layout 12 may allow the users/listener to select the type of recording to be played. The methodology 10 then in a second section may test the listener's ability to understand the audio recording through a user input and verification process. As shown in the drawings, a user may first access the listening interactive software 10 at its main screen and navigate through any number of drop down menus in order to select the language 14, category 16, sub-category 18 and level 20 along with the speed 22 at which the audio recording should be read. The methodology 10 may be used to increase the listener's ability to understand someone speaking to them in a language which is new to them or is their native language. As shown in the figures, the user may first select a language 14 which the recording may be read into the listener using the methodology 10. Any known language may be used for the methodology 10 as described herein. Languages that may be used, but are not limited to, may include Parisian French, Quebecois French, Latin American Spanish, Iberian Spanish, German, Mandarin, Italian (including individual dialects), American English, British English, or any other known language known to man may be used in the methodology 10 to improve the listeners understanding of the spoken word of that language. After the language 14 is selected by the user of the methodology 10, the category or topic 16 of the recordings the user/listener wishes to listen to and a subcategory 18 where appropriate may be chosen. The categories 16 may range from any known topic, such as but not limited to, business, conversational, commercial, or any other known topic relating to a language may be sorted by the voice recordings made for such language. It should be noted that the voice recordings may be made by an actual real life person or by computer generation of the chosen language. The subcategory 18 drop down menu may break down the main categories, such as business, into different specific areas, such as job interviews, client interaction, meeting protocol, client retention, marketing, etc. or any other known spoken words that may be used in business contexts. Once the category 16 and subcategory 18 are selected, the user/listener may select the current level 20 of the user's vocabulary with the language chosen to be listened to. Generally, the level 20 is broken down into beginner, intermediate or advanced. This may allow for the listener to listen to spoken vocal recordings more appropriate to their level of similarity and comfortableness with the language chosen to be listened to. The advanced level in comparison to the beginner level may use more sophisticated words, conjunctions, and different tenses of the spoken word compared to that of the beginner level, which would be more basic terminology being spoken. After the level 20 has been chosen by the user/listener, the user/listener may determine and set the speed 22 at which the user wishes the recording to be spoken to them via the computer or other device. In one contemplated embodiment the speed 22 may be set at fast, regular, slow or word by word. This may allow for the listener to choose the speed 22 at which the spoken word is spoken to them via the computer or other device. Next, the user/listener may choose a recording code number 24 which may allow the listener to choose an individual recording to be used as a starting point for the current session of listening by the user. Once all of the menu items have been selected by the user, the user may press or activate the play button 26 on the interactive screen to listen to the recording via the computer or other device. It should be noted that any known way of converting the spoken word into an audio file may be used and the audio file may be of any known type that is capable of being broadcast over a speaker, either directly within the computer, laptop, handheld device, being used by the user or via an external speaker, headset, ear buds, etc., either wirelessly or hard wired to the device that may allow for the spoken word to actually be heard by the user using the methodology 10 of the present invention.

After the user presses the play button 26, the recording may be heard by the user. The user can then listen to the recording as often as he or she wishes. At any time after playing the vocal recording chosen the user may then type into the input text box 28 area on the interactive screen what the user thinks he or she has heard. The user can again listen to the recording if they wish at the same or a different speed while viewing what the user wrote in the input area 28. This may occur many times or one time depending on the comfort level of the user with the methodology 10 and with what they heard. The ability of the methodology 10 to have this play/write iteration may continue until the user either thinks what has been typed is correct or the user cannot improve on what they think they heard further without help from the methodology interactive software 10. Hence, the user transforming the spoken word heard via the vocal recording into typed words on a computer screen are helping themselves with listening and helping to increase their ability to understand someone speaking to them in a language chosen by them.

After the user types in what they think is correct, after either listening once to the vocal recording or listening to the vocal recording multiple times at any of the speeds, the user will press or activate the submit button 30 of the methodology interactive software 10. It should be noted that the interactive software menus, dropdowns and any other controls may be activated or controlled with a keyboard, mouse, pen, or any other device capable of controlling an electronic device, as long as the device is capable of having a keyboard or any other known way of inputting letters to create the words the listener believes they have heard using the methodology 10. After the submit button 30 is activated the user's inputted text will appear in the result or second text box 32 directly below the type in your input box 28 on the interactive viewing screen 12. The inputted text will appear in the result box 32 with correct and incorrect words identified by a variety of colors or shapes. In one contemplated embodiment, correctly spelled words may appear in a green font. Incorrectly spelled words or wrong words that do not belong may appear in a red font. Missing words are indicated with a blank underlined in red. Incorrect letter case may have an orange font. Incorrect punctuation may be indicated with an asterisk. It should further be noted that the methodology may also inform the user of the percent corrections of their submission for the vocal recording currently being heard. This mark 31 for the percent correct generally is arranged adjacent to or next to the result box 32 on the interactive screen 12. Hence, if seventy five percent of what the user types in the input box 28 is correct the mark 34 may show a percentage of seventy five percent. The same may be true for any other percentage of the typed words matching that of the vocal recording listened to by the user. Hence, the user provided with this detailed feedback can then again listen to the recording at the same or another speed 22 and correct their submission accordingly. At any point the user may press the submit button 30 once again to verify the most recent input typed into box 28 on the interactive screen 12. The user may repeat this cycle as often as the user wishes until they get what they heard from the vocal recording completely correct or until they cannot improve on what they have heard via the inputted answer 28. Furthermore, at any time the user may reveal the correct answer by pressing or activating the correct answer icon or button 36. Upon activating this icon or button 36, the text of the recording, as spoken, may then be displayed in the answer box 38 located near the bottom of the screen 12 directly below the result box 32. The answer box 38 may show the correct words spoken by the vocal recording along with the correct punctuation and case of the spoken word in typed form. This will allow the user to see directly what they were hearing in order to help them understand the spoken word of the language 14 chosen to be heard.

The user may then choose any other recording from the same category 16 or subcategory 18 chosen or may choose a completely different category 16, subcategory 18, recording 24 and even a different language 14 and skill level 16 and continue with their improvement of listening and understanding the spoken word via the interactive software and methodology 10 disclosed herein. The user may also use either the next button 40 or back button 42 to automatically listen to the next or previous vocal recording in the sequence of chosen parameters, if they so wish.

It is also contemplated in another embodiment of the present invention to augment the vocal recording of the methodology by making a video recording of the speaker and then displaying the speaker's image when the sound recording is played. This may be advantageous to the user as much as the user will have mastered lip reading to help improve their understanding of the spoken word of the language chosen. It may also allow the system to help deaf people improve their lip reading ability by looking at a person speaking the chosen vocal recording and then inputting what the person believes they heard/saw, via lip reading, into the typed answer box 28.

Yet in another embodiment of the present invention it is contemplated to have the vocal recording augmented with a computer generated image of a talking head showing the facial responses required to make the recording by the speaker, and then displaying this image when the sound recording is played. This may be advantageous to the user as much as the user has mastered lip reading which helps to increase the ability to understand someone speaking to them in a language which is new to them. It may also allow the system to help deaf persons to improve their lip reading ability via viewing the spoken word in video format with a computer generated video person. It should be noted that any other known interaction of the spoken word, such as via sign language or any other interactive language may also be used and incorporated into the methodology 10 disclosed herein to improve the listeners understanding of the spoken or signed word. Another contemplated embodiment of the software may have a voice recognition system, so that the user listens to a recording, and then responds by orally repeating what the user interpreted as the recording, and the voice recognition system then enters into the answer textbox 28 the text it has converted from oral response of the user.

The methodology 10 of the present invention may be used in any known form, such as those described above and in one proposed and contemplated embodiment may improve a listeners understanding of the spoken word via interactive software using an interactive screen device. This system may include a main database used in conjunction with the methodology 10. The main database will generally store and transfer databases of voice recordings and a client database. These databases may work in conjunction with the interactive software to create the methodology 10. In one contemplated embodiment the interactive software may include a payment software (HWLpayhere.com) and a listening software to help with listening (Helpwithlistening.com). It should further be noted that any of the databases or software used in the methodology 10 described herein may be of any known form and use any known coding or language to write the software and database programs.

In one contemplated embodiment the user interactive software and databases as described above, may have the user contact a listening software through or via a website and have the user choose to register and pay or increase payments to use the software or go directly to the listening program 10. If the user is registering or increasing payment, the user goes directly to a pay service, such as PayPal, however any other pay service, such as credit card payment, etc., may also be used for the methodology 10 contemplated herein. After the payment is completed the pay service informs the listening software of the presence of such payment. The methodology 10 may then create a client record on the client database, if one does not exist, using an user ID, and password selected by the user and update the client record with the payment. If a client record already exists, the methodology 10 may update the client record with the new payment information. In one contemplated embodiment the total money paid may be converted into usable minutes of the interactive listening software 10. The methodology 10 may then inform the user of the time now available for use with the help with listening interactive software.

Next, the user may enter a user ID and a password to enter the methodology interactive software 10. The methodology 10 may verify the information and check for any useable minutes available. The system may then inform the user of the time available and the user may then be directed to the webpage or an interactive screen 12 to start listening to the vocal recordings. The user may then use the interactive screen 12 as described above to listen to the spoken word and then enter what they think they heard and get results shown and the percentage correct of what they heard versus what was actually spoken. The methodology 10 may keep track of the time used by the user in the interactive help with listening program 10. It may update the client database as the time is used. It is also contemplated to have people purchase a vocal recording individually, such that each vocal recording will cost a set fee to be listened to as many times as the user wishes. In the methodology as described herein, when there is approximately five minutes remaining in the client's account, the methodology may inform the user of the program 10. The user may then use the pay service and add more time by purchasing more usable minutes.

When there is no time remaining, the user may be informed of such on the screen 12. The user may then proceed to purchase additional minutes or if the user does not wish to do so, the user's record may be deleted from the database. It should be noted that it is contemplated in the current methodology 10 that the client's database may be reviewed periodically and hence, any client user ID that has useable minutes, but has not been used for over a designated time, such as but not limited to six months, the client record may be deleted. It should be noted that multiple users may simultaneously use the same client user ID and password, thus allowing for a teacher in a school environment, etc., to provide funding for a classroom of learners trying to understand and improve their ability to comprehend the spoken word. Therefore, having the interactive software as a web based program may allow for multiple users to use the software at the same time from any known location throughout the world. It should be noted that this is just one contemplated embodiment of making the software available for use to users. Other contemplated methodologies may use other payment types or may be available for use without payments. Therefore, the methodology 10 may be an interactive web based software that is capable of being accessed via the internet by any known user using any known device, either wirelessly or hard wired into the internet and/or world wide web.

Another alternate embodiment of the teaching methodology of improving the listeners understanding of the spoken word 10 may be to supply teachers of second languages or regular teachers of native languages with specially designed decks of cards 46, which may have a predetermined logo on the back of the card 46 and a single saying, which may be used to create a vocal recording for the embodiment disclosed above, on the face of the card 46. The cards 46 may be used in several ways, such as the teacher may read a card at a given speed, i.e., a regular speed, and then the students may write on a piece of paper or type into their computers what they think they have heard. In this alternate embodiment of the methodology, the teacher may then evaluate the individual student's answers manually or electronically. Then depending on those results, the teacher may read the same sentence at a slower speed and then reevaluate the results at that speed and so on and so forth until the students grasp and gain a better understanding of the spoken word of the native or second language. It should also be noted that the cards 46 for use with the methodology to improve the listeners understanding of the spoken word may also be used where the teacher gives each student a different card 46. The teacher may then ask, a predetermined order or by random selection, a student to read the card 46, following which the other students must write down the name of the reader and what they think that reader had read. It should be noted that with the student reading the saying on the face of the card 46, more repetition in the readings may at times be necessary. This embodiment of the use of the cards 46 exercises both the reading and listening skills of the students who are new to the second language. It should further be noted that many decks of cards 46 with the same or different levels of vocabulary may be compiled and produced, hence these would be distributed as ordered by instructors or school board executives or their equivalent as needed. It should further be noted that the deck of cards 46 with the different sayings may have different durabilities and costs, hence providing structured cards at a variety of prices for different school districts and learning centers.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A method of improving a listeners understanding of the spoken word, said method comprising the steps of:
preparing a set of vocal recordings;
selecting one of said vocal recordings to be played for the listener;
listening by the listener to said one of said vocal recordings;
inputting by the listener into a predetermined form the words heard during said listening; and
verifying accuracy of said inputted words to actual words spoken in said one of said vocal recordings.

2. The method of claim 1 wherein said step of preparing comprises videotaping a person speaking words in said vocal recording.

3. The method of claim 1 wherein said step of preparing comprises printing words on a card, said card is read by a speaker to the listener.

4. The method of claim 1 wherein said step of preparing comprises recording words spoken by a speaker onto a permanent medium.

5. The method of claim 1 further comprising the step of storing said vocal recordings on an electronic device.

6. The method of claim 1 wherein said step of selecting comprises choosing a language.

7. The method of claim 1 wherein said step of selecting comprises choosing a category which said vocal recording is related to.

8. The method of claim 7 wherein said step of selecting comprises choosing a subcategory of said category of said vocal recording.

9. The method of claim 6 wherein said step of selecting comprises choosing a level of expertise of said language.

10. The method of claim 9 wherein said step of selecting comprises choosing a speed at which said vocal recording will be spoken to the listener.

11. The method of claim 1 wherein said step of selecting comprises choosing a recording code number related to said one of said vocal recordings.

12. The method of claim 1 wherein said step of inputting comprises the listener typing words heard into an electronic device.

13. The method of claim 1 wherein said step of inputting comprises the listener writing words heard onto paper.

14. The method of claim 1 wherein said step of verifying comprises displaying on a screen of an electronic device what percent correct the listener achieved in said inputting.

15. The method of claim 14 wherein said step of verifying comprises displaying on a screen of an electronic device what errors were made in said inputted words.

16. The method of claim 15 wherein said errors are shown in a red font for spelling mistakes, in red underline for missing words and with an asterisk for wrong punctuation.

17. The method of claim 1 further comprising the step of displaying a correct answer to the words spoken in said vocal recording spoken to the listener.

18. The method of claim 1 further comprising the step of replaying said one of said vocal recordings or choosing a next or a previous of said vocal recordings for listening by the listener.

19. A method of improving a listeners understanding of the spoken word via an electronic device, said method comprising the steps of:
using a set of vocal recordings, said vocal recordings are accessible to the electronic device;
selecting one of said vocal recordings to be played via the electronic device for the listener;
listening to said one of said vocal recordings by the listener;
inputting words heard during said listening of said one of said vocal recordings by the listener into the electronic device; and
verifying accuracy of said inputted words to actual words spoken in said one of said vocal recordings.

20. The method of claim 19 wherein said step of preparing comprising videotaping or animating a person speaking words of said vocal recording.

21. The method of claim 19 wherein said step of selecting comprises:
choosing a language for said vocal recordings;
choosing a category for said vocal recordings;
choosing a subcategory for said category of said vocal recordings;
choosing a level of expertise of said language; and
choosing a speed at which said vocal recordings are spoken to the listener.

22. The method of claim 19 wherein said step of selecting comprises choosing a recording code number related to a specific said vocal recording or a next or back said vocal recording.

23. The method of claim 19 wherein said step of verifying comprises:
displaying on a screen of the electronic device or another device what percent correct the listener achieved in said inputting;
displaying on said screen of the electronic device or another device what errors were made in said inputted words; and
displaying on said screen of the electronic device or another device a correct answer to words spoken in said one of said vocal recordings.
